(19) United States
(12) Patent Application Publication
(10) Pub. No.: US 2022/0102091 A1
(43) Pub. Date: Mar. 31, 2022

(54) Electrical Switch with an Adjustable Tactile Profile and/or an Adjustable Audio Profile

(71) Applicants: Nicholas Daniel Caspers, Bloomington, MN (US); John Alexander Caspers, Bloomington, MN (US)

(72) Inventors: Nicholas Daniel Caspers, Bloomington, MN (US); John Alexander Caspers, Bloomington, MN (US)

(21) Appl. No.: 17/033,650

(22) Filed: Sep. 25, 2020

(51) Int. Cl. H01H 13/84; H01H 13/14; H01H 13/04; H01H 13/20; H01H 13/52; H01H 13/86

(52) U.S. Cl. CPC H01H 13/84; H01H 13/14; H01H 13/04; H01H 13/20; H01H 2235/01; H01H 13/86; H01H 2013/525; H01H 2215/03; H01H 13/52

(57) ABSTRACT

Example aspects of the present disclosure are directed to an electrical switch with an adjustable tactile profile and/or an adjustable audio profile. One example includes an electrical switch with a pushbutton, a plunger, two metal contacts, a biasing spring, and a housing body. A user can press and move the pushbutton. The pushbutton's movement can move the plunger. The plunger's movement can cause the plunger to create or break a conductive connection between the metal contacts. Specifically, at least one unique actuator surface of two or more unique actuator surfaces on the plunger can engage the metal contacts. Changing the tactile profile can involve changing the unique actuator surface engaging the metal contacts. The conductive connection can indicate whether the electrical switch is in an unpressed or pressed state. The biasing spring can bias the electrical switch to the unpressed state. The housing body can contain the other components.

### FIELD

The present disclosure relates generally to electrical switches and, more particularly, to electrical switches designed towards particular tactile profiles and/or audio profiles.

### BACKGROUND

Inputting information into computers is often done through computer keyboards. Computer keyboards contain a set of electrical switches where engagement with the electrical switches is communicated to the computer. Specifically, when a computer keyboard key is pressed, two metal terminals are conductively connected. The conductive connection is interpreted by the computer that the computer key corresponding to those metal terminals has been pressed.

Given the prevalence of personal computers, electrical switches in computer keyboards have been well-developed. For instance, a wide range of electrical switches have been created for the sake of a more satisfying tactile profile or audio profile. Examples of tactile profiles include linear tactile profiles and bump tactile profiles. A linear tactile profile means that the electrical switch's responding force to being pressed increases linearly as the electrical switch is pressed. A bump tactile profile means the electrical switch's responding force spikes as the electrical switch is pressed. Pressing the electrical switch feels like going over a bump. Audio profiles range from strict silence for open-office settings to enhanced clicking that is often desired by typists.

Although a rich field of tactile profiles and audio profiles exist, tactile profiles and audio profiles of electrical switches cannot be altered easily. Altering an electrical switch's tactile profile and/or audio profile, particularly the tactile profile, often requires replacing the entire electrical switch or most of the electrical switch's internal parts. Additional electrical switch parts are required. Fully replacing electrical switches is a tedious process. Usually multiple electrical switches, if not all of the electrical switches on a keyboard, are being replaced. Additionally, electrical switches are often soldered and well-integrated into the keyboard. Such integration can make replacement impossible. Those difficulties with replacing an electrical switch spill over into difficulties in replacing a switch's internal parts which includes an additional process of breaking open an electrical switch and swapping out the parts.

Changing an electrical switch's tactile profile and/or audio profile can be useful. Why should a keyboard or electrical switch be restricted to a single tactile profile and a single audio profile? A buyer of a keyboard or set of electrical switches could end up disliking the tactile profile or the audio profile. To mitigate the chance of a regretful purchase, a variety pack of singleton electrical switches can be bought for testing. However, wouldn't it be better to test out an electrical switch by typing out on a full keyboard with that electrical switch? Additionally, a single keyboard often takes on multiple roles. Different roles are better served by different electrical switches. Typing enthusiasts often want bump tactile profiles. Office workers need electrical switches that create less noise. Video games often require double-tapping an electrical switch which is handled better by electrical switches with linear tactile profiles. Without being able to change an electrical switch's tactile profile and/or audio profile, each role requires a whole new keyboard or set of electrical switches.

### SUMMARY

Aspects and advantages of embodiments of the present disclosure will be set forth in part in the following description, or may be learned from the description, or may be learned through practice of the embodiments.

One example aspect of the present disclosure is directed to an electrical switch with at least an adjustable tactile profile. This electrical switch can include a pushbutton, a plunger, two metal contacts, a biasing spring, and a housing body. The pushbutton can take an external force which can cause the pushbutton to move, and the pushbutton's movement can cause the plunger to move. The plunger's movement can cause the plunger to engage with at least one of the two metal contacts. Specifically, the plunger can have two or more unique actuator surfaces where at least one of those unique actuator surfaces is what can engage the metal contacts. The engagement can create or break a conductive connection between the two metal contacts. The created or broken conductive connection can indicate that the electrical switch is in a pressed state. The electrical switch can be biased to an unpressed state by a biasing force from the biasing spring on the pushbutton. The biasing force can cause the pushbutton to move away from the metal contacts. The pushbutton's movement causes the plunger to withdraw from engaging the metal contacts. Such withdrawing can restore the state of the conductive connection prior to the plunger's engagement. Each component—the pushbutton, the plunger, the two metal contacts, and the biasing spring—can be contained by the housing body.

A second example aspect of the present disclosure is directed to an electrical switch with at least an adjustable audio profile. This electrical switch can include a pushbutton, a plunger, two metal contacts, a biasing spring, and a housing body. The pushbutton can take an external force which can cause the pushbutton to move, and the pushbutton's movement can cause the plunger to move. Additionally, the pushbutton can have one or more pushbutton locking surfaces which can match one or more plunger locking surfaces on the plunger. The pushbutton locking surfaces and the plunger locking surfaces can be unlocked from one another or locked together. Unlocked locking surfaces means that the pushbutton and plunger can move separately from one another. Locked locking surfaces means that the pushbutton and plunger can move together as one piece. The plunger's movement due to the pushbutton under the external force can cause the plunger to engage with at least one of the two metal contacts. Specifically, the plunger can have one or more unique actuator surfaces where at least one of those unique actuator surfaces is what can engage the metal contacts. The engagement can create or break a conductive connection between the two metal contacts. The created or broken conductive connection can indicate that the electrical switch is in a pressed state. The electrical switch can be biased to an unpressed state by a biasing force from the biasing spring on the pushbutton. The biasing force can cause the pushbutton to move away from the metal contacts. The pushbutton's movement causes the plunger to withdraw from engaging the metal contacts. Such withdrawing can restore the state of the conductive connection prior to the plunger's engagement. Each component—the pushbutton, the plunger, the two metal contacts, and the biasing spring—can be contained by the housing body.

A third example aspect of the present disclosure is directed to a keyboard with a plurality of electrical switches that are configured to have an adjustable tactile profile and/or an adjustable audio profile. The keyboard can include a keyboard housing body, a computing device, and a plurality of electrical switches. The keyboard housing body can contain the computing device and the plurality of electrical switches. The computing device, which can include one or more processors, can be communicatively coupled to the plurality of electrical switches to interpret whether a given switch is in a pressed state or unpressed state. The plurality of electrical switches can be configured to have an adjustable tactile profile and/or an adjustable audio profile. Each electrical switch can include a pushbutton, a plunger, two metal contacts, a biasing spring, and a housing body. The pushbutton can take an external force which will cause the pushbutton to move, and the pushbutton's movement causes the plunger to move. The plunger's movement can cause the plunger to engage with at least one of the two metal contacts. Specifically, the plunger can have two or more unique actuator surfaces where at least one of those unique actuator surfaces is what can engage the metal contacts. The engagement can create or break a conductive connection between the two metal contacts. The created or broken conductive connection can indicate that the electrical switch is in a pressed state. The electrical switch can be biased to an unpressed state by a biasing force from the biasing spring on the pushbutton. The biasing force can cause the pushbutton to move away from the metal contacts. The pushbutton's movement causes the plunger to withdraw from engaging the metal contacts. Such withdrawing can restore the state of the conductive connection prior to the plunger's engagement. Each component—the pushbutton, the plunger, the two metal contacts, and the biasing spring—can be contained by the housing body.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an exploded view of an electrical switch with an adjustable tactile profile and an adjustable audio profile;

FIG. 2 depicts a cross-section of an electrical switch, similar to the electrical switch in FIG. 1, in an unpressed state, with the pushbutton and the plunger being unlocked, and with the bump actuator surface being in a position to engage the metal contacts;

FIG. 3 depicts a cross-section of an electrical switch, similar to the electrical switch in FIG. 1, in a pressed state, with the plunger slamming against the lower housing body, and with the bump actuator surface engaging the metal contacts;

FIG. 4 depicts a cross-section of an electrical switch, similar to the electrical switch in FIG. 1, in an unpressed state, with the pushbutton and the plunger being locked together, and with the linear actuator surface being in a position to engage the metal contacts;

FIG. 5 depicts a cross-section of an electrical switch, similar to the electrical switch in FIG. 1, in a pressed state, with the pushbutton and the plunger moving together as one piece, and with the linear actuator surface engaging the metal contacts;

FIG. 6 depicts an exploded view of an upper housing body, a pushbutton, and a partially exposed plunger of an electrical switch, similar to the electrical switch of FIG. 1, where a rotation in the upper housing body or the pushbutton can manipulate the plunger;

FIG. 7 depicts a keyboard with a keyboard housing body housing a computing device and a plurality of electrical switches; and

FIG. 8 depicts a block diagram of a computing device.

### DETAILED DESCRIPTION

Reference now will be made in detail to embodiments, one or more examples of which are illustrated in the drawings. Each example is provided by way of explanation of the embodiments, not limitation of the invention. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to an electrical switch with an adjustable tactile profile and/or an adjustable audio profile. The tactile profile and audio profile of an electrical switch is the force and the sound, respectively, felt and heard by a user when the electrical switch is pressed. For instance, with a computer keyboard, the force on a user's finger as the user presses the key is the tactile profile. The sound produced (e.g. a thud or a click) as the user presses the key is the audio profile.

Specifically, example aspects can be directed to embodiments that detail electrical switches where the tactile profile and/or the audio profile can be adjusted solely through the parts in the electrical switch. In some embodiments, adjusting the tactile profile and/or the audio profile can include disassembling, manipulating parts, and reassembling the electrical switch. In some embodiments, adjusting the tactile profile and/or the audio profile can require manipulating (e.g. rotating) parts of the electrical switch without disassembling the electrical switch.

An example embodiment can entail a pushbutton, a plunger, two metal contacts, a biasing spring, and a housing body. The pushbutton is the component that a user can interact with to switch the electrical switch on and off. The pushbutton can take an external force by the user pressing on the switch. The pushbutton can transfer that force to the plunger. The plunger, upon moving from the transferred external force, can engage with at least one of the two metal contacts. Specifically, at least one of two or more unique actuator surfaces on the plunger can engage with at least one of the two metal contacts. The unique actuator surface engaging with the metal contacts can define the tactile profile. Therefore, choosing what unique actuator surfaces engages the metal contacts can change the tactile profile. The engagement by the unique actuator surface can create or break a conductive connection between the metal contacts. The change in the conductive connection between the two metal contacts can indicate that the electrical switch is in a pressed state. The electrical switch can be biased to an unpressed state by a biasing force from the biasing spring on the pushbutton. Such a biasing force can move the pushbutton away from the metal contacts. The pushbutton's movement causes the plunger to withdraw from engaging the metal contacts. Such withdrawing can restore the state of the conductive connection prior to the plunger's engagement. Those components—the pushbutton, the plunger, the two metal contacts, and the biasing spring—can be contained by the housing body.

The pushbutton can be used to take an external, pressing force by a user. The external, pressing force can cause the pushbutton to move vertically along the electrical switch. The pushbutton's movement can cause the plunger to move in the same direction. For instance, when a user engages the electrical switch, engaging the electrical switch can be pressing the electrical switch. The pushbutton can be the component to take on that engagement or pressing. Pressing the pushbutton can cause the pushbutton to move downward along the electrical switch which can further cause a downward pushing or movement by a plunger. In some implementations, the plunger can be the shape of a ring. The plunger ring can sit around the pushbutton and under a ridge on the pushbutton. Therefore, an external, pressing force on the push button can move the plunger. The plunger's movement can be sliding alongside, and in the same direction of, the pushbutton.

The plunger, moved by the pushbutton, can engage with at least one of the two metal contacts. Specifically, the plunger can have two or more unique actuator surfaces where at least one of those unique actuator surfaces can engage with at least one of the two metal contacts. An actuator surface can be a surface on the plunger that can engage with another component (e.g. the metal contacts). Engaging can include actions such as, for example, moving, sliding against, pushing, actuating, and interacting. More particularly, the engagement by the unique actuator surfaces can entail creating or breaking a conductive connection between the metal contacts. If the relationship between the metal contacts prior to engagement is the lack of a conductive connection, the engagement can create a conductive connection. If the relationship between the metal contacts prior to engagement is a conductive connection, the engagement can break the conductive connection. Additionally, the plunger withdrawing from engagement, which can occur due to the biasing force of the biasing spring, can reset the conductive connection between the metal contacts to the state prior to engagement.

The actuator surfaces can be primarily responsible for defining the tactile profile of an electrical switch. The tactile profile of an electrical switch can be determined from the felt force on a user as the user presses the electrical switch. For instance, if the only force felt by a user pressing the switch is the biasing force from the biasing spring, the tactile profile would be considered a linear tactile profile. As the user presses against the biasing spring, a consistent, linear increase of force is produced on the pushbutton by the biasing spring. An actuator surface engaging with the metal contacts can produce additional force on the pushbutton and, therefore, can define the tactile profile. With two or more unique actuator surfaces, an electrical switch can have multiple, different tactile profiles.

In some embodiments, the set of unique actuator surfaces can include linear actuator surfaces and/or bump actuator surfaces. A linear actuator surface can be a smooth, flat surface. The linear actuator surface engaging with the metal contacts does not provide much additional force on the pushbutton. Without the engagement providing additional force, the biasing force from the biasing spring can define the tactile profile. As stated previously, a biasing spring with a consistent, linear increase in force can create a linear tactile profile.

A bump actuator surface can be a surface with a bump along the surface. The bump actuator surface engaging with the metal contacts can provide a disjointed force to define the tactile profile. Specifically, as the bump actuator surface engages with the metal contacts, the additional force on the pushbutton can increase steadily and can be followed by a sharp drop when the bump is cleared. As expected, a user feels like they went over a bump. Hence, a bump actuator surface can create a bump tactile profile.

Moving on to adjusting the audio profile, in some embodiments, plunger can have locking surfaces that match with locking surfaces on the pushbutton. In some implementations, the locking surfaces can be interrupted threads, locking lugs, or matching locking ridges and locking recesses. Unlocking the matching locking surfaces allows the pushbutton and the plunger to move independently of one another. Locking the matching locking surfaces forces the pushbutton and the plunger to stay together throughout the entire press of the electrical switch.

Whether the pushbutton and plunger are unlocked or locked together can define the audio profile. When the pushbutton and plunger are unlocked, pressing the electrical switch can produce an enhanced click. The loud click can be created by the plunger slamming against the housing body. For instance, when a bump actuator surface engages the metal contacts, an increase in force followed by a sharp decrease in force can be felt by the user. The change in force corresponds to the metal contacts following the bump actuator surface. The initial increase can be the metal contacts pushing underneath the bump on the bump actuator surface. The sharp decrease can be the metal contacts clearing the bump. After clearing the bump, the metal contacts can be pushing down on the top of the bump. If the pushbutton and the plunger are unlocked, the plunger can move independently from the pushbutton, and the only force on the plunger after the bump being cleared can be the metal contacts pushing on top of the bump. The force of the metal contacts on the top of the bump forces the plunger downward to slam against the housing body. Locking the pushbutton and plunger together can reduce the noise produced by pressing the electrical switch. The plunger can not move separately from the pushbutton, and the biasing spring can always apply a biasing force on the pushbutton to keep the pushbutton from slamming against the housing body.

The plunger can create or break a conductive connection between the two metal contacts. Specifically, the plunger engaging with the metal contacts changes the state of the conductive connection between the metal contacts from the default—unpressed—state. The creating or the breaking of a conductive connection away from the default state can indicate that the electrical switch is in the pressed state. If the default state of the two metal contacts is the lack of a conductive connection, the change created by the plunger engaging with the metal contacts is to create a conductive connection. If the default state of the two metal contacts is a conductive connection, the change created by the plunger engaging with the metal contacts is to break the conductive connection.

Regardless of the state of the electrical switch, the biasing spring can apply a biasing force on the pushbutton against the external, pressing force on the pushbutton. The biasing spring can be any kind of mechanical spring or combination of mechanical springs. For instance, the biasing spring can include a coil spring, a flat spring, and/or a v-shaped spring. The biasing force can bias the electrical switch to the unpressed state. The unpressed state can occur when metal contacts are not engaged by the plunger. The plunger can not engage with the metal contacts if the pushbutton is moving away from the metal contacts. In some implementations, the pushbutton can have hooks, ridges, lugs, or arms to pull the plunger up—away from the metal contacts—with the pushbutton. The external, pressing force can move the pushbutton and the plunger to engage—towards—the metal contacts. The biasing force can push the pushbutton in the opposite direction of the external pressing force. Therefore, the biasing spring can bias the electrical switch to the unpressed state.

The components of the electrical switch can be contained by the housing body. For instance, the housing body can contain, or partially enclose, the pushbutton, the plunger, the two metal contacts, and the biasing spring. In some implementations, the housing body can include two pieces: an upper housing body and a lower housing body. The pieces can be separated for disassembly and reassembly of the electrical switch by a user. For instance, tight friction fit, screw threading, locking ridges and recesses, and accessible, external retention hooks can allow the pieces to be separated and put back together by a user. The pieces can be fit together to restrict disassembly after initial assembly. For instance, inaccessible, internal retention hooks or tight friction fit with internal locking ridges and recesses can keep the pieces from being separated after initial assembly.

The ability to separate the pieces can determine the ways that the tactile profile and/or the audio profile can be adjusted. In some embodiments, disassembly is the only way to access components to adjust the tactile profile and/or the audio profile. For instance, disassembly can be required to rotate or to move the pushbutton and/or the plunger in order to determine what actuator surface engages the metal contacts. In embodiments with matching locking surfaces on the pushbutton and the plunger, disassembly can be required to move the pushbutton and/or the plunger in order to determine whether the pushbutton and the plunger are locked or unlocked.

In some embodiments, accessing components for adjusting the tactile profile and/or audio profile can be done without disassembly. For instance, similar to how the pushbutton can be accessible to take on an external, pressing force, the pushbutton can be accessible without disassembly. The housing body can expose—to make accessible without disassembly—parts of a plunger. The pushbutton and/or the plunger can be made accessible indirectly through the housing body. Specifically, a piece of the housing body (e.g. the upper housing body) can be rotated or moved for the sake of changing the tactile profile and/or the audio profile. Such rotation or movement can cause further rotation or movement in the pushbutton and/or the plunger. The resulting rotation or movement of the pushbutton and/or the plunger through any of the previously stated ways can adjust the tactile profile and/or the audio profile. Rotation or movement of the pushbutton and/or plunger can determine what actuator surface engages the metal contacts and/or whether the pushbutton and plunger are locked or unlocked.

Example aspects of the present disclosure provide a number of technical effects and benefits. For instance, the electrical switch embodiments detail an electrical switch whose tactile profile and/or audio profile can be adjusted without replacing parts. Changing the tactile profile and/or the audio profile on current electrical switches can effectively entail replacing the switch entirely. Furthermore, there can be numerous ways of interacting with the electrical switch to adjust the tactile profile and/or the audio profile. In particular, one embodiment details that changing the tactile profile and/or the audio profile can be as easy as rotating a piece of the housing body. The electrical switch does need to be disassembled.

With reference now to the Figures, example embodiments of the present disclosure will now be discussed in detail.

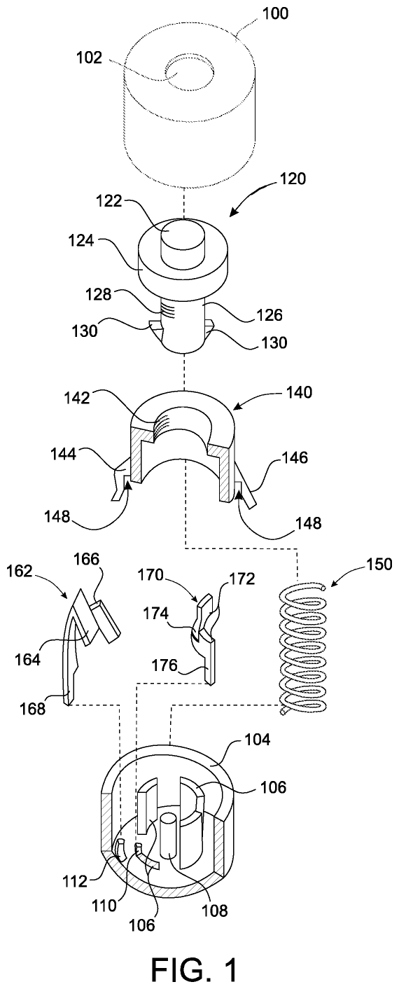

FIG. 1 depicts an electrical switch 180 with an adjustable tactile profile and an adjustable audio profile. The electrical switch 180 is broken up into a housing body comprising 100 and 104, a pushbutton 120, a plunger 140, a biasing spring 150, and two metal contacts comprising 162 and 170. The housing body is split into an upper housing body 100 and a lower housing body 104. The upper housing body 100 can be easily separated from the lower housing body 104. In some embodiments, such separation is not meant to occur. In this example, the upper housing body 100 and the lower housing body 104 fit together via a friction fit. In other embodiments, the upper housing body 100 and the lower housing body 104 can fit together via screw threading, locking ridges and recesses, and accessible, external retention hooks.

The upper housing body 100 keeps the pushbutton 120 and the plunger 140 from leaving the electrical switch 180 under a biasing force from the biasing spring 150. The upper housing body 100 has a pushbutton opening 102 to expose a top portion 122 of the pushbutton 120. Exposing the top portion 122 allows a user to access the pushbutton 120 in order to press the electrical switch 180. However, the pushbutton opening 102 is smaller than a stopper 124 on the pushbutton 120. The size of the stopper 124 ensures that the pushbutton 120 cannot leave the electrical switch 180 through the pushbutton opening 102. Because the plunger 140 sits between the stopper 124 and stem lugs 130 of the pushbutton 120 in this example, if the pushbutton 120 cannot leave the electrical switch 180, the plunger 140 cannot leave the electrical switch 180.

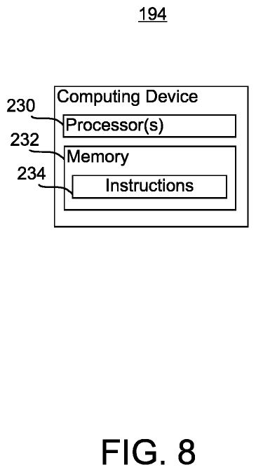

The lower housing body 104 holds together the biasing spring 150 and the two metal contacts comprising 162 and 170. The two metal contacts include a dynamic metal contact 162 and a static metal contact 170. The biasing spring 150 is held in place and kept straight by a spring rail 108 on the lower housing body 104. The dynamic metal contact 162 is held in place by a dynamic metal contact slot 112 in the lower housing body 104. The static metal contact 170 is held in place by a static metal contact slot 110 in the lower housing body 104. The dynamic metal contact slot 112 and the static metal contact slot 110 allow the terminals of the metal contacts, the dynamic metal contact terminal 168 and the static metal contact terminal 176, to be exposed outside of the housing body. Exposing the terminals—168 and 176—allows a computing device (e.g. the computing device 194 found in the block diagram in FIG. 8) to be conductively connected to the electrical switch 180. Such a conductive connection allows the computing device 194 to be able to interpret whether the electrical switch 180 is in an unpressed state or a pressed state.

In this example, the lower housing body 104 also keeps the plunger 140 from rotating while the plunger 140 is traveling along the electrical switch 180. The lower housing body 104 has guiding rails 106 to maintain the orientation of the plunger 140. Specifically, the guiding rails 106 guide the unique actuator surfaces—a bump actuator surface 144 and a linear actuator surface 146 in this example—along a straight path as the plunger 140 travels vertically. Because the unique actuator surfaces—144 and 146—are parts of the plunger 140, keeping the unique actuator surfaces—144 and 146—on a straight path keeps the plunger 140 from rotating during travel.

Moving on to the pushbutton 120, the pushbutton 120 is meant to take on an external force from a user pressing on the electrical switch 180. The pushbutton's movement from the user pressing on the electrical switch 180 causes the pushbutton 120 to move the plunger 140. Specifically, in this example, the user pressing on the electrical switch 180 causes the pushbutton 120 to move vertically along the electrical switch 180 against a biasing force from the biasing spring 150. The pushbutton 120 is configured to ensure that the plunger 140 follows the pushbutton's movement in some degree.

On a downstroke—the initial press on the pushbutton 120—the pushbutton's movement causes the plunger 140 to move downward with the pushbutton 120 either by the stopper 124 or the pushbutton's locking surfaces 128 and the plunger's locking surfaces 142 being locked together. The stopper 124 pushes down on top of the plunger 140 as the plunger 140 sits underneath the stopper 124 and around the stem 126 of the pushbutton 120. This situation occurs when the pushbutton's locking surfaces 128 and the plunger's locking surfaces 142 are unlocked from one another. The pushbutton's locking surfaces 128 and the plunger's locking surfaces 142, in this example, are interrupted threads although other examples can include locking lugs, or locking ridges and locking recesses. The pushbutton's locking surfaces 128 and the plunger's locking surfaces 142 being locked together cause the pushbutton 120 and the plunger 140 to move together as one piece.

On an upstroke—the pushbutton 120, under the biasing force, following the user withdrawing from pressing the electrical switch—the pushbutton 120 forces the plunger 140 to follow the pushbutton's movement either through the stem lugs 130 or a locked relationship between the pushbutton's locking surfaces 128 and the plunger's locking surfaces 142. If the two sets of locking surfaces—128 and 142—are not locked together, the plunger 140 can move separately along the stem 126 of the pushbutton 120. In this case, the stem lugs 130, which in other examples could be hooks, ridges, or arms, catch the underside of the plunger 140 and pull the plunger 140 up with the pushbutton 120 on an upstroke. If the two sets of locking surfaces—128 and 142—are locked together, the pushbutton 120 and plunger 140 move together as one piece. The plunger 140 will directly follow the pushbutton 120 on an upstroke as oppose to sliding along the stem 126 until reaching the stem lugs 130.

Moving on to the plunger 140, the plunger 140 is meant to engage with the metal contacts—162 and 170—to create or to break a conductive connection between the metal contacts. In this example, the plunger 140 engages the dynamic metal contact 162. On a downstroke, the plunger 140 creates a conductive connection between the dynamic metal contact and the static metal contact indicating a pressed state. On an upstroke, the plunger 140 breaks the conductive connection between the dynamic metal contact 162 and the static metal contact 170 indicating a return to an unpressed state. However, in other embodiments the creating and the breaking of the conductive connection to indicate the pressed state or the unpressed state can be reversed. This movement of and engagement by the plunger 140 determines the tactile profile and the audio profile of the electrical switch 180.

The tactile profile is determined from the unique actuator surface on the plunger—either a bump actuator surface 144 or a linear actuator surface 146 in this example—engaging the dynamic metal contact 162. Although the majority of the force a user feels from pressing the electric switch 180 is the biasing force of the biasing spring 150, the additional force from the dynamic metal contact 162 sliding along a unique actuator surface defines the tactile profile.

For instance, the bump actuator surface 144 creates a disjointed force to define the tactile profile. The disjointed force comes from the bump in the bump actuator surface 144. The additional force on the pushbutton 120 steadily increases as the dynamic metal contact 162 approaches the peak of the bump. The plunger 140 needs to be pushed harder for the dynamic metal contact 162 to clear the bump. The steady increase is followed by a sharp drop when the bump is cleared. Instead of the dynamic metal contact 162 pushing up from underneath the bump, the dynamic metal contact pushes down from above the bump. As expected, the user feels like they went over a bump. Hence, a bump actuator surface 144 can create a bump tactile profile.

The linear actuator surface 146 creates little to no additional force on the pushbutton 120. The lack of additional force is because the linear actuator surface 146 has a smooth, flat surface. No extra resistance is found from the dynamic metal contact 162 sliding along the linear actuator surface 146. Without additional force, the biasing force from the biasing spring 150 defines the tactile profile. The biasing spring 150 provides a consistent, linear increase in force as the electrical switch 180 is pressed, which creates a linear tactile profile.

The plunger's movement across the dynamic metal contact 162 determines the audio profile. The unlocked or locked relationship between the pushbutton's locking surfaces 128 and the plunger's locking surfaces 142 determines how the plunger 140 moves across the dynamic metal contact 162. For instance, when the pushbutton 120 and the plunger 140 are unlocked from one another, the audio profile is an enhanced click. When the bump actuator surface 144 moves across the dynamic metal contact 162, an increase in force and a following sharp decrease in force can be felt by the user. The initial increase is the dynamic metal contact 162 pushing underneath the bump on the bump actuator surface 144. The sharp decrease is the dynamic metal contact 162 clearing the bump 145. However, after clearing the bump, the dynamic metal contact 162 starts pushing down from above the bump. The only force on the plunger 140 is the dynamic metal contact 162 pushing down on bump which is part of the bump actuator surface 144 on the plunger 140. With the pushbutton's locking surfaces 128 and the plunger's locking surfaces 142 being unlocked from one another, the plunger 140 can move separately from the pushbutton 120. Therefore, the downward force on the plunger 140 causes the plunger 140 to slam against the lower housing body 104. The plunger 140 slamming against the lower housing body 104 produces a loud clicking sound.

When the pushbutton's locking surfaces 128 and the plunger's locking surfaces 142 are locked together, the plunger's movement across the dynamic metal contact 162 lends to a more silent audio profile. With a locked relationship, the plunger 140 cannot move separately from the pushbutton 120, and the pushbutton 120 always moves in a controlled manner because the biasing spring 150 constantly applies a consistent biasing force on the pushbutton 120. The pushbutton 120 cannot slam, unless the user really presses the pushbutton 120 hard, against the lower housing body 104.

Moving on to the biasing spring 150, the biasing spring 150 provides a biasing force against the pushbutton 120. The biasing force goes against an external force from a user pressing on the electrical switch 180. In going against the external, pressing force, the biasing force biases the electrical switch to an unpressed state. In this example, the biasing spring 150 is a coil spring, but any mechanical spring (e.g. a flat spring or v-shaped spring) can provide the same functionality.

Lastly, the two metal contacts include a dynamic metal contact 162 and a static metal contact 170. In this example, the dynamic metal contact 170 is a v-shaped spring with, on one end, the dynamic metal contact terminal 168 and, on the other end, an engaging surface 164 and a contact flap 166. As discussed previously, the dynamic metal contact terminal 168 allows an external conductive connection to the dynamic metal contact 162. The dynamic metal contact 162 is a v-shaped spring to provide spring pressure against the unique actuator surface engaging the dynamic metal contact 162. The spring pressure biases the dynamic metal contact 162 to be conductively connected—touching—the static metal contact 170. With this spring pressure, as the plunger 140 engages and withdraws from engagement, the dynamic metal contact's engaging surface 164 follows the unique actuator surface. As the plunger 140 moves downward, the dynamic metal contact 162 extends towards the static metal contact 170. The dynamic metal contact 162 follows the unique actuator surface's inward slope with respect to moving up the unique actuator surface. When the electrical switch 180 is in a pressed state, the plunger 140 moves far enough down as to allow the dynamic metal contact 162 to extend and touch the static metal contact 170. The contact flap 166 touches the static metal contact 170. As the plunger 140 moves upwards, the dynamic metal contact 162 is compressed and moves away from the static metal contact 170. The dynamic metal contact 162 follows the unique actuator surface's outward slope with respect to moving down the unique actuator surface.

In this example, the static metal contact 170 is designed to have an external conductive connection outside the electrical switch 180, to be conductively connected with the dynamic metal contact 162, and to be out of the way of the plunger 140 traveling about the electrical switch 180. As discussed previously, the static metal contact 170 has a static metal contact terminal 176 that sits outside of the lower housing body 104. The exposed static metal contact terminal 176 allows an external conductive connection to the static metal contact 170. The static metal contact 170 has contact surfaces 172 for the contact flap 166 of the dynamic metal contact 162 to touch upon the extension of the dynamic metal contact 162. To ensure no hindering the plunger's movement, the static metal contact 170 has a contact cutout 174 matching a plunger cutout 148. For instance, when the electrical switch 180 is setup to have a loud audio profile, the contact cutout 174 and the plunger cutout 148 allow the plunger 140 to slam against the lower housing body 104. Without the contact cutout 174 and plunger cutout 148, the plunger 140 would slam against the static metal contact 170.

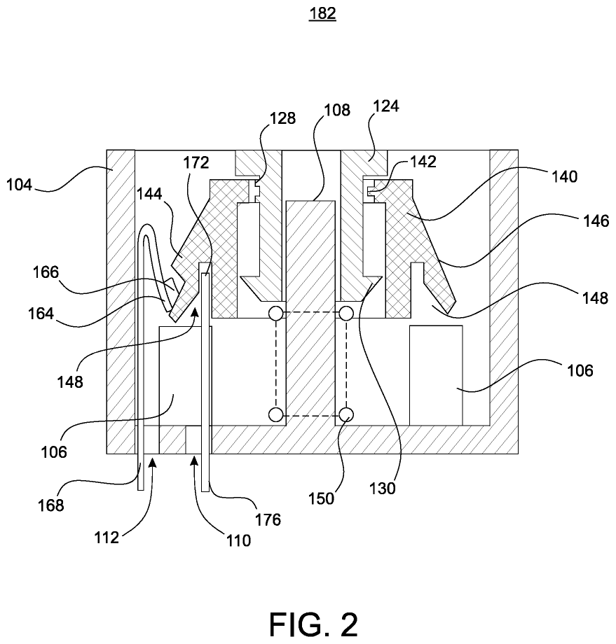

FIGS. 2-5 depict cross-sections of electrical switches, similar to the electrical switch 180 of FIG. 1, with varying combinations of whether the electrical switch is in an unpressed state or a pressed state, whether a pushbutton and a plunger are unlocked or locked, and whether a bump actuator surface or a linear actuator surface is engaging the metal contacts.

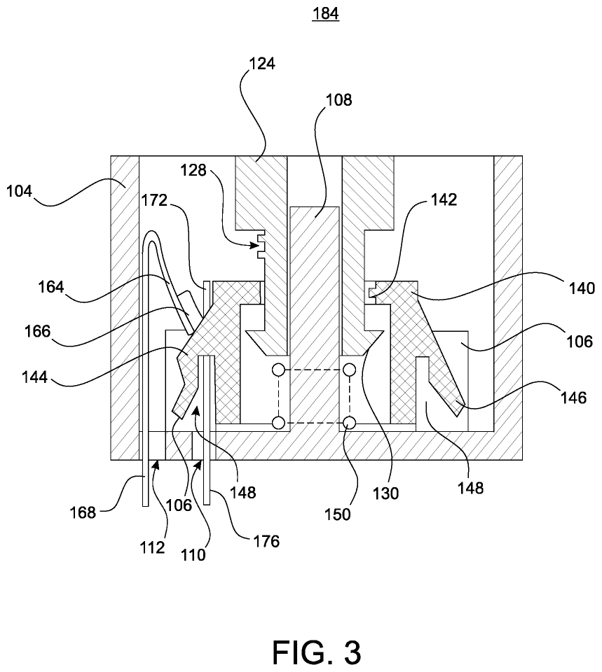

FIG. 2 and FIG. 3 each depict a cross-section of an electrical switch—182 and 184—where the electrical switch has a pushbutton and a plunger in an unlocked relationship and a bump actuator surface being in a position to engage metal contacts. In FIG. 2, with the electrical switch 182 in the unpressed state, the dynamic metal contact 162 is compressed against the lowermost point of the bump actuator surface 144. This causes the contact flap 166 of the dynamic metal contact 162 to be separated from the contact surfaces 172 of the static metal contact 170. Additionally, the spring pressure of the dynamic metal contact 162 on the lowermost point of the bump actuator surface 144 holds up the unlocked plunger 140. The unlocked plunger 140 is indicated by the plunger's locking surfaces 142 and the pushbutton's locking surfaces 128.

In FIG. 3, with the electrical switch 184 in the pressed state, the dynamic metal contact's engaging surface 164 has cleared the bump in the bump actuator surface 144, and the dynamic metal contact 162 is extended against the uppermost point of the bump actuator surface 144. This causes the contact flap 166 of the dynamic metal contact 162 to come in contact with the contact surfaces 172 of the static metal contact 170. Additionally, after the engaging surface 164 cleared the bump, the spring pressure from the dynamic metal contact 162 is directed down on the top of the bump actuator surface 144. The dynamic metal contact's downward spring pressure forced the unlocked plunger 140 to greater separate from the pushbutton and slam against the lower housing body 104.

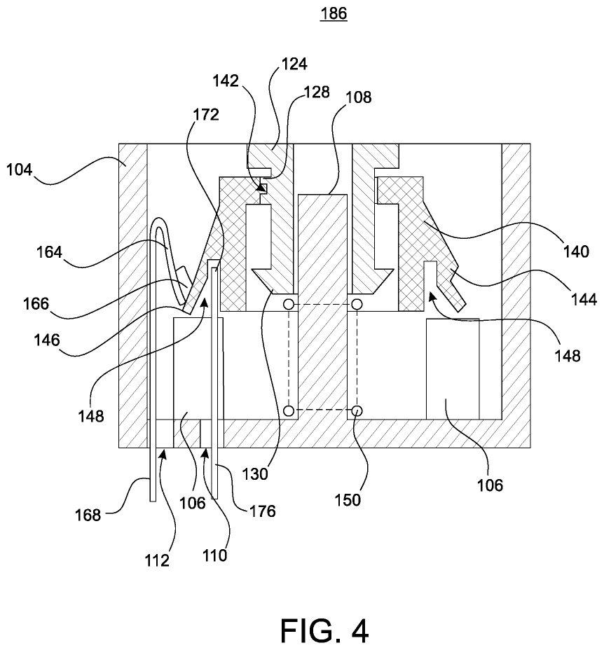

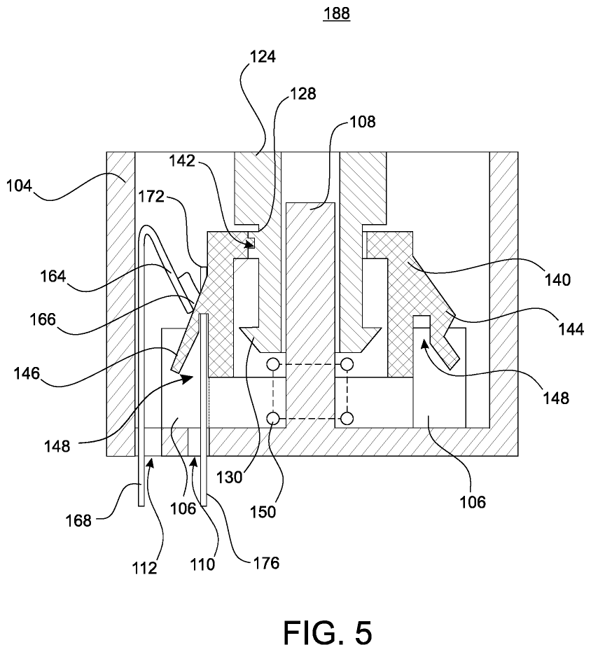

FIG. 4 and FIG. 5 each depict a cross-section of an electrical switch—186 and 188—where the electrical switch has a pushbutton and a plunger in a locked relationship and with a linear actuator surface being in a position to engage metal contacts. In FIG. 4, with the electrical switch 186 in the unpressed state, the dynamic metal contact 162 is compressed against the lowermost point of the linear actuator surface 146. This causes the contact flap 166 of the dynamic metal contact 162 to be separated from the contact surfaces 172 of the static metal contact 170. Unlike the unlocked plunger 140 in FIG. 3, the plunger 140 in FIG. 5 is locked with the pushbutton 120 as indicated by the plunger's locking surfaces 142 and the pushbutton's locking surfaces 128. Therefore, the plunger 140 is not held up by the v-spring spring pressure of the dynamic metal contact 162.

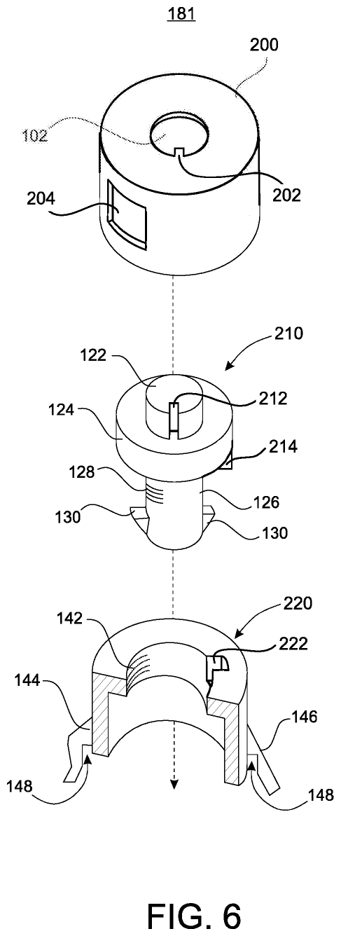

In FIG. 5, with the electrical switch 188 in the pressed state, the dynamic metal contact's engaging surface 164 has moved up the linear actuator surface 146 and is extended against the uppermost point of the linear actuator surface 144. This causes the contact flap 166 of the dynamic metal contact 162 to come in contact with the contact surfaces 172 of the static metal contact 170. Unlike the unlocked plunger 140 in FIG. 4, the plunger 140 in FIG. 6 is locked with the pushbutton 120, remains with the pushbutton 120 as indicated by the plunger's locking surfaces 142 and the pushbutton's locking surfaces 128. This keeps the plunger 140 from slamming against the lower housing body 104.

FIG. 6 depicts an upper housing body 200, a pushbutton 210, and a plunger 220 of an easily manipulated electrical switch 181 with similar parts to the electrical switch in FIG. 1. An easily manipulated electrical switch can be an electrical switch where the tactile profile and/or the audio profile can be changed without disassembling the electrical switch. In this example, the easily manipulated electrical switch 181 includes an upper housing body 200 and a pushbutton 210 that can be rotated to manipulate the plunger 220. The upper housing body 200 has a housing body lug 202 which fits into a pushbutton recess 212 in the pushbutton 210. Rotating the upper housing body 200 can cause rotation in the pushbutton 210. The pushbutton 210 has a pushbutton lug 214 which fits into a plunger recess 222 in the plunger 220. Rotation in the pushbutton 210 can cause rotation in the plunger 220. Alongside indirectly manipulating the plunger 220 through the upper housing body 200 or the pushbutton 210, the upper housing body 200 has a plunger exposing hole 204 that exposes a portion of the plunger 220. Through the plunger exposing hole 204, the plunger 220 can be manipulated directly. Manipulating the plunger 220 (e.g. rotating the plunger 220) can change what unique actuator surfaces engage the metal contacts or whether the pushbutton locking surfaces and the plunger locking surfaces are unlocked from one another or locked together. Changing the engaging unique actuator surfaces or the state of the pushbutton locking surfaces and the plunger locking surfaces can change the tactile profile and/or the audio profile.

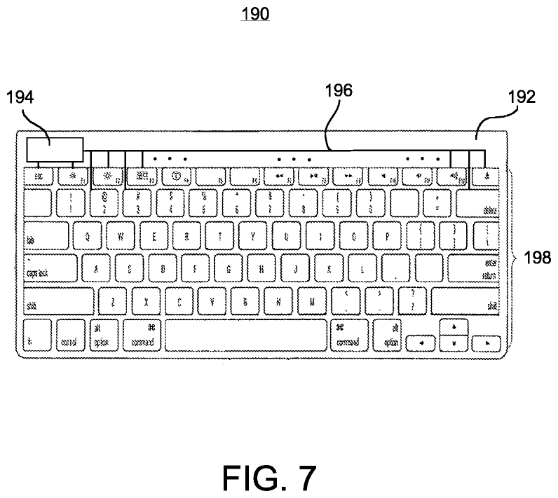

FIG. 7 depicts a keyboard 190 with a keyboard housing body 192 housing a computing device 194 and a plurality of electrical switches 198 that have an adjustable tactile profile and/or an adjustable audio profile. The computing device 190 can interpret the current state of an electrical switch or for each electrical switch in the plurality of electrical switches 198.

More specifically, as shown in the block diagram in FIG. 8, the computing device 194 can include one or more processors 230 and a memory 232. The one or more processors 230 can be any form of processing device, including, for example, a processing unit, a microprocessor, a controller, a microcontroller, an application specific integrated circuit, etc. The memory 232 can include one or more of any non-transitory computer-readable medium, including, for example, RAM (e.g., DRAM), ROM (e.g., EEPROM), optical storage, magnetic storage, flash storage, solid-state storage, hard drives, or some combination thereof. The memory 232 can store one or more sets of instructions 234 that, when executed by the computing device, cause the computing device to perform operations consistent with the present disclosure (e.g. interpreting the states of the electrical switches).

In order to be able to interpret the states of the electrical switches 198, the computing device 194 can be communicatively coupled to each electrical switch of the plurality of electrical switches 198. The communicative couplings 196 can include any manner of providing a conductive connection between the computing device 194 and the metal contacts for each electrical switch of the plurality of electrical switches 198. For instance, the communicative coupling 196 can include a set of wires. The computing device 194 can be hardwired via the set of wires to the metal contacts of each electrical switch of the plurality of electrical switches. The communicative coupling 196 can include a printed circuit board with traces to provide the conductive connection between the computing device 194 and the metal contacts of each electrical switch of the plurality of electrical switches 198.

While the present subject matter has been described in detail with respect to specific example embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one skilled in the art.

1. An electrical switch with at least an adjustable tactile profile, comprising:
a pushbutton to take an external force to move the pushbutton which will move a plunger;
the plunger to engage with at least one of two metal contacts, wherein:
the plunger comprises two or more unique actuator surfaces, wherein one of the two or more unique actuator surfaces engages the at least one of the two metal contacts; and
the plunger engaging the at least one of the two metal contacts creates or breaks a conductive connection between the two metal contacts;
the two metal contacts where the conductive connection that was created or broken by the plunger engaging the at least one of the two metal contacts indicates a pressed state, while a lack of the conductive connection that was created or broken by the plunger engaging the at least one of the two metal contacts indicates an unpressed state;
a biasing spring to apply a biasing force on the pushbutton in a direction going against the external force, wherein the biasing force causes the plunger to withdraw from engaging the at least one of the two metal contacts, wherein the plunger withdrawing breaks or creates the conductive connection that was created or broken from the plunger engaging the at least one of the two metal contacts; and
the housing body to contain the pushbutton, the plunger, the two metal contacts, and the biasing spring.

2. The electrical switch with at least an adjustable tactile profile of claim 1, wherein the pushbutton can be rotated to change the one of the two or more unique actuator surfaces that engages with the at least one of the two metal contacts.

3. The electrical switch with at least an adjustable tactile profile of claim 1, wherein the two or more unique actuator surfaces comprise at least a linear actuator surface or a bump actuator surface.

4. The electrical switch with at least an adjustable tactile profile of claim 1, wherein;
the pushbutton comprises one or more pushbutton locking surfaces; and
the plunger comprises one or more plunger locking surfaces;
wherein the one or more pushbutton locking surfaces and the one or more plunger locking surfaces can be locked together or not locked together, wherein:
when the one or more pushbutton locking surfaces and the one or more plunger locking surfaces are locked together, the pushbutton and the plunger to move together; and
when the one or more pushbutton locking surfaces and the one or more plunger locking surfaces are not locked together, the pushbutton and the plunger can move separately.

5. The electrical switch with at least an adjustable tactile profile of claim 4, wherein the one or more pushbutton locking surfaces and the one or more plunger locking surfaces comprise a set of interrupted threads.

6. The electrical switch with at least an adjustable tactile profile of claim 4, wherein the one or more pushbutton locking surfaces and the one or more plunger locking surfaces comprise three locking lugs, wherein a first locking lug of the three locking lugs fits in between a second locking lug of the three locking lugs and a third locking lug of the three locking lugs.

7. The electrical switch with at least an adjustable tactile profile of claim 1, wherein the housing body comprises an opening that exposes a portion of the plunger, wherein the portion of the plunger that is exposed can be interacted with to change the one of the two or more unique actuator surfaces that engages with the at least one of the two metal contacts.

8. The electrical switch with at least an adjustable tactile profile of claim 1, wherein the housing body comprises:
an upper housing body that can be rotated to change the one of the two or more unique actuator surfaces that engages with the at least one of the two metal contacts; and
a lower housing body.

9. The electrical switch with at least an adjustable tactile profile of claim 4, wherein the housing body comprises:
an upper housing body that can be rotated to change either or both:
the one of the two or more unique actuator surfaces that engages with the at least one of the two metal contacts; and
whether the one or more pushbutton locking surfaces and the one or more plunger locking surfaces are unlocked or locked together; and
a lower housing body.

10. An electrical switch with at least an adjustable audio profile, comprising:
a pushbutton to take an external force to move the pushbutton which will move a plunger, wherein the pushbutton comprises one or more pushbutton locking surfaces;
the plunger to engage with at least one of two metal contacts, wherein:
the plunger comprises:
one or more plunger locking surfaces; and
one or more unique actuator surfaces, wherein one of the one or more unique actuator surfaces engages the at least one of the two metal contacts; and
the plunger engaging the at least one of the two metal contacts creates or breaks a conductive connection between the two metal contacts;
the one or more pushbutton locking surfaces and the one or more plunger locking surfaces can be locked together or not locked together, wherein:
when the one or more pushbutton locking surfaces and the one or more plunger locking surfaces are locked together, the pushbutton and the plunger to move together; and
when the one or more pushbutton locking surfaces and the one or more plunger locking surfaces are not locked together, the pushbutton and the plunger can move separately;
the two metal contacts where the conductive connection that was created or broken by the plunger engaging the at least one of the two metal contacts indicates a pressed state, while a lack of the conductive connection that was created or broken by the plunger engaging the at least one of the two metal contacts indicates an unpressed state;
a biasing spring to apply a biasing force on the pushbutton in a direction going against the external force, wherein the biasing force causes the plunger to withdraw from engaging the at least one of the two metal contacts, wherein the plunger withdrawing breaks or creates the conductive connection that was created or broken from the plunger engaging the at least one of the two metal contacts; and
a housing body to contain the pushbutton, the plunger, the two metal contacts, and the biasing spring.

11. A keyboard comprising:
a keyboard housing body for containing a computing device and a plurality of electrical switches;
the computing device comprising one or more processors, wherein the computing device is communicatively coupled to the plurality of electrical switches to interpret a pressed state or an unpressed state for each electrical switch of the plurality of electrical switches; and
the plurality of electrical switches that are configured for at least an adjustable tactile profile or an adjustable audio profile, wherein each electrical switch of the plurality of electrical switches comprises:
a pushbutton to take an external force to move the pushbutton which will move a plunger;
the plunger to engage with at least one of two metal contacts, wherein:
the plunger comprises two or more unique actuator surfaces, wherein one of the two or more unique actuator surfaces engages the at least one of the two metal contacts; and
the plunger engaging the at least one of the two metal contacts creates or breaks a conductive connection between the two metal contacts;
the two metal contacts where the conductive connection that was created or broken by the plunger engaging the at least one of the two metal contacts indicates the pressed state, while a lack of the conductive connection that was created or broken by the plunger engaging the at least one of the two metal contacts indicates the unpressed state;
a biasing spring to apply a biasing force on the pushbutton in a direction going against the external force, wherein the biasing force causes the plunger to withdraw from engaging the at least one of the two metal contacts, wherein the plunger withdrawing breaks or creates the conductive connection that was created or broken from the plunger engaging the at least one of the two metal contacts; and
a housing body to contain the pushbutton, the plunger, the two metal contacts, and the biasing spring.

12. The keyboard of claim 11, wherein, for at least one electrical switch of the plurality of electrical switches, the pushbutton can be rotated to change the one of the two or more unique actuator surfaces that engages with the at least one of the two metal contacts.

13. The keyboard of claim 11, wherein, for at least one electrical switch of the plurality of electrical switches, the two or more unique actuator surfaces comprise at least a linear actuator surface or a bump actuator surface.

14. The keyboard of claim 11, wherein, for at least one electrical switch of the plurality of electrical switches:
the pushbutton comprises one or more pushbutton locking surfaces; and
the plunger comprises one or more plunger locking surfaces;
wherein the one or more pushbutton locking surfaces and the one or more plunger locking surfaces can be unlocked or locked together, wherein:
the one or more pushbutton locking surfaces and the one or more plunger locking surfaces being locked together forces the pushbutton and the plunger to move together; and
when the one or more pushbutton locking surfaces and the one or more plunger locking surfaces are unlocked, the pushbutton and the plunger can move separately.

15. The keyboard of claim 14, wherein, for at least one electrical switch of the plurality of electrical switches, the one or more pushbutton locking surfaces and the one or more plunger locking surfaces comprise a set of interrupted threads.

16. The keyboard of claim 14, wherein, for at least one electrical switch of the plurality of electrical switches, the one or more pushbutton locking surfaces and the one or more plunger locking surfaces comprise three locking lugs, wherein a first locking lug of the three locking lugs fits in between a second locking lug of the three locking lugs and a third locking lug of the three locking lugs.

17. The keyboard of claim 11, wherein, for at least one electrical switch of the plurality of electrical switches, the housing body comprises an opening that exposes a portion of the plunger, wherein the portion of the plunger that is exposed can be interacted with to change the one of the two or more unique actuator surfaces that engages with the at least one of the two metal contacts.

18. The keyboard of claim 11, wherein, for at least one electrical switch of the plurality of electrical switches, the housing body comprises:
an upper housing body that can be rotated to change the one of the two or more unique actuator surfaces that engages with the at least one of the two metal contacts; and
a lower housing body.

19. The keyboard of claim 14, wherein, for at least one electrical switch of the plurality of electrical switches, the housing body comprises:
an upper housing body that can be rotated to change either or both:
the one of the two or more unique actuator surfaces that engages with the at least one of the two metal contacts; and
whether the one or more pushbutton locking surfaces and the one or more plunger locking surfaces are unlocked or locked together; and
a lower housing body.
